(19) United States
(12) Patent Application Publication
(10) Pub. No.: US 2008/0298336 A1
(43) Pub. Date: Dec. 4, 2008

(54) MACRO-DIVERSITY TECHNIQUE FOR MULTICAST TRANSMISSION IN A WIRELESS COMMUNICATION SYSTEM

(76) Inventor: SRIDHAR GOLLAMUDI, Morris Plains, NJ (US)

Correspondence Address: MARK W. SINCELL;Williams, Morgan & Amerson, P.C., Suite 1100, 10333 Richmond, Houston, TX, 77042, US

(21) Appl. No.: 11/756,013

(22) Filed: May 31, 2007

(51) Int. Cl. H04J 1/00

(52) U.S. Cl. 370/343

(57) ABSTRACT

The present invention provides a method multicasting that provides macro-diversity. Embodiments of the method may include receiving, at a mobile unit, a plurality of encoded signals indicative of at least one packet over a corresponding plurality of substantially orthogonal frequency channels associated with a plurality of transmitters. The method may also include demodulating the information indicative of the packet(s) using the plurality of encoded signals and storing the demodulated information.

### BACKGROUND OF THE INVENTION

1. Field of the Invention

This invention relates generally to communication systems, and, more particularly, to wireless communication systems.

2. Description of the Related Art

Wireless communication systems can be used to transmit a single stream of data to numerous mobile units using point-to-multipoint transmission schemes such as broadcasting or multicasting. The term “multicasting” conventionally refers to either multicasting or broadcasting. For example, the users of a group of mobile units may subscribe to a multicast service, such as a pay-per-view service, that streams audio and/or video to the mobile units at selected times. In conventional hierarchical wireless communications, a multicast server transmits multicast data (including the data used to generate the audio and/or video) to a central element such as such as a Radio Network Controller (RNC). The RNC may then transmit paging messages to the subscribed mobile units via one or more base stations. The mobile units may establish a wireless link to one or more of the base stations in response to receiving the page from the wireless communication system. A radio resource management function within the RNC receives the multicast data and coordinates the radio and time resources used by the set of base stations to transmit the multicast. The radio resource management function can perform fine grain control to allocate and release resources for multicast transmission over a set of base stations.

Base stations in some conventional wireless communication systems transmit multicast signals in each cell independently of transmissions by the base stations that serve neighboring cells. In this type of system, each multicast receiver (e.g., each subscribed mobile unit) receives the multicast signal from a single transmitter that provides wireless connectivity to the cell or sector that includes the multicast receiver. The multicast receivers do not combine this signal with signals from transmitters or base stations in neighboring cells. Thus, the base stations that multicast to different cells or sectors do not coordinate their multicast transmissions. Consequently, signals from neighboring cells may interfere with the multicast signal transmitted by the serving base station. Systems that offer broadcast and multicast services over Multicast/Broadcast Multimedia Services (MBMS) channels defined in the UMTS standard are examples of systems that provide multicast services in this manner. Although independent transmission schemes that do not allow combining of signals from neighboring cells may be relatively simple to implement, they may also have a number of disadvantages. For example, multicast users at the edge of the cell experience significant interference from neighboring cells, which can severely limit their achievable data rates. The overall performance of a multicast system is limited by the worst-case users, so this limit on the data rates for edge users can also substantially reduce the overall performance of the multicast system.

Coordinating the transmissions of data from a set of base stations (which may be referred to hereinafter as the soft handover group) may permit the mobile units to merge incoming signals to boost the signal-to-noise ratio at the mobile unit. In the case of transmissions using the Code Division Multiple Access (CDMA) protocols, each base station transmits data to the subscribed mobile units using a different code such as a pseudorandom scrambling code. The mobile unit receives energy over the different code channels through its antenna and combines the information received on the different code channels before attempting to decode the information, i.e., the mobile units perform soft combining of signals from multiple base stations. However, soft combining information received on different code channels does not reduce all components of the noise in each code channel. For example, if data is transmitted concurrently on first and second channels, transmissions on the first channel typically include interference from concurrent transmissions on the second channel, and vice versa. Soft combining does not remove this interference.

A Single Frequency Network (SFN) is one alternative method of transmitting multicast signals over multiple cells in systems that use a small signal bandwidth (narrowband signals) or OFDM modulation. In the case of a single frequency network, signals carrying the same information are transmitted simultaneously from different cells using the same transmission format so that they constructively (or destructively) combine with each other to yield a received signal whose power is the sum of the powers received from all the transmitters. Additionally, signals from one base station do not appear as interference to the signal from another base station if the modulation is selected such that the symbol duration is much larger than the effective delay spread. Under these conditions the power received from different cells for a particular symbol add up at the receiver and do not appear as interference. Narrowband signaling and Orthogonal Frequency Division Multiplexing (OFDM) are examples of modulation schemes that satisfy this criterion, and are hence particularly suited for SFN operation. OFDM modulation divides the transmitted signal into a number of narrowband signals, or sub-carriers, each of which is very tolerant of delay spread in the received signal. Single frequency networks can potentially boost the signal-to-noise ratio of a multicast signal received at a mobile unit by providing an increase in the received power of the desired signal as well as reduction of interference.

However, single frequency networks are significantly more difficult to implement and operate than other multicast systems. Single frequency networks require very tight synchronization of transmitted frames between different cells. For example, the symbol timing across cells must be synchronized to within a small fraction of the cyclic prefix, which is usually on the order of a few microseconds in typical cellular deployments. This requirement can be fulfilled using a standard technique to synchronize a network, for example, using GPS timing. However, implementing GPS or a similar technology would significantly increase the complexity of the system. Furthermore, a system that relies on GPS signaling may not be suitable for applications that are deployed indoors or otherwise out of the line of site of a sufficient number of satellites to make accurate position determinations.

Single frequency networks also require that the same packet be transmitted simultaneously from all the cells. This requires coordination between the base stations to schedule the same multicast packet for transmission in the same time slot across the entire network. To meet this requirement, either the association of a time slot to the information-bearing packet that is transmitted in that time slot must be predefined across the entire network or fast communication must exist between all the base stations to instantaneously coordinate their respective packet schedulers. Simultaneous packet transmission also places stringent constraints on the relative delays with which packets arrive over the backhaul at the different base stations for multicast transmission. Time stamping and/or buffering of the backhaul traffic may be necessary in some cases. Furthermore, the backhaul network may not provide sufficient delay guarantees if the backhaul network is based on the Internet Protocol (IP).

In conventional hierarchical networks, the coordination and/or synchronization of base station transmissions needed to implement single frequency macro-diversity may be provided by a central entity in the network such as the radio network controller. However, this central entity may not exist in all networks. For example, one alternative to the conventional hierarchical network architecture is a distributed architecture including a network of access points, such as base station routers or femto-cells, which implement distributed communication network functionality. For example, each base station router or femto-cell may combine RNC and/or PDSN functions in a single entity that manages radio links between one or more mobile units and an outside network, such as the Internet. Base station routers wholly encapsulate the cellular access technology and may proxy functionality that utilizes core network element support to equivalent IP functions. For example, IP anchoring in a UMTS base station router may be offered through a Mobile IP Home Agent (HA) and the GGSN anchoring functions that the base station router proxies by through equivalent Mobile IP signaling. Compared to hierarchical networks, distributed architectures have the potential to reduce the cost and/or complexity of deploying the network, as well as the cost and/or complexity of adding additional wireless access points, e.g. base station routers, to expand the coverage of an existing network. Distributed networks may also reduce (relative to hierarchical networks) the delays experienced by users because packet queuing delays at the RNC and PDSN of hierarchical networks may be reduced or removed.

Distributed architectures do not, however, include a central element that is capable of hosting the radio resource management functions that are needed to support broadcast services. In particular, distributed architectures may lack a central entity that can enforce coordination and/or synchronization of signals by the base station routers, and it may add excessive complexity and cost to the network to support such coordination. Broadcasts in distributed architectures are therefore difficult to synchronize in a manner that permits soft combining of transmissions from a group of base station routers. Furthermore, single frequency networks are difficult to implement in systems where the backhaul is not easily synchronized between the cells, such as a cellular system based on a flat or distributed IP architecture, where the backhaul for each base station or base station router is an IP network. Consequently, distributed architectures may not be able to take advantage of the techniques that are commonly used to boost the signal-to-noise ratios of broadcast transmissions in hierarchical systems.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, methods are provided for multicasting that provides macro-diversity. Embodiments of the methods may include receiving, at a mobile unit, a plurality of encoded signals indicative of at least one packet over a corresponding plurality of substantially orthogonal frequency channels associated with a plurality of transmitters. The method may also include demodulating the information indicative of the packet(s) using the plurality of encoded signals and storing the demodulated information. Other embodiments of the methods may include transmitting, from a first transmitter, a first encoded signal indicative of at least one packet over a first frequency channel. At least one second encoded signal indicative of the packet is also transmitted by at least one second transmitter over at least one second frequency channel that is substantially orthogonal to the first frequency channel.

### BRIEF DESCRIPTION OF THE DRAWINGS

The invention may be understood by reference to the following description taken in conjunction with the accompanying drawings, in which like reference numerals identify like elements, and in which:

FIG. 1A conceptually illustrates a first exemplary embodiment of a wireless communication system, in accordance with the present invention;

FIG. 1B conceptually illustrates a frequency re-use pattern that may be implemented in wireless communication systems, such as the first exemplary embodiment of the wireless communication system depicted in FIG. 1, in accordance with the present invention;

FIG. 2 conceptually illustrates a second exemplary embodiment of a wireless communication system, in accordance with the present invention; and

FIG. 3 conceptually illustrates one exemplary embodiment of a method of a macro-diversity technique that may be used for multicasting in wireless communication systems, such as the first and/or the second exemplary embodiments of the wireless communication system depicted in FIG. 1A and FIG. 2, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

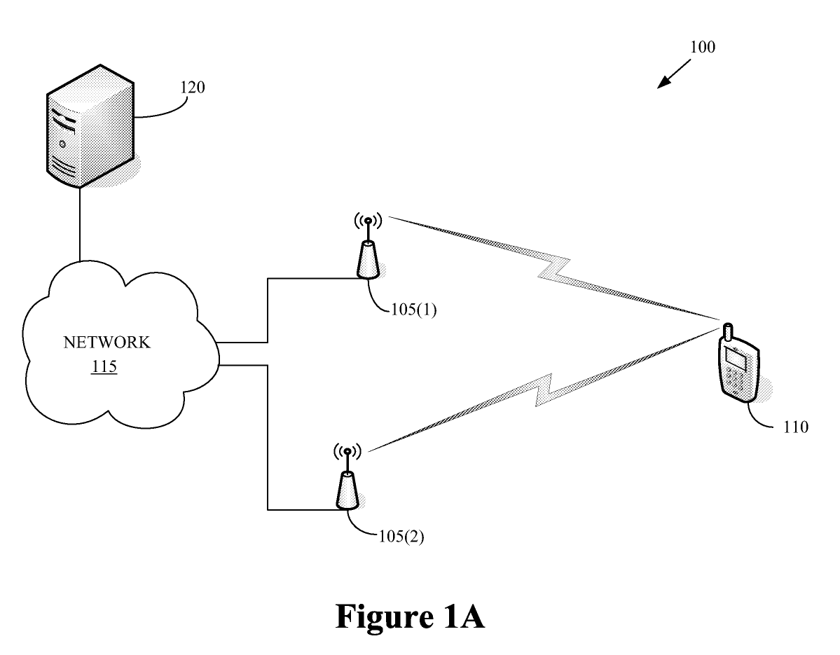

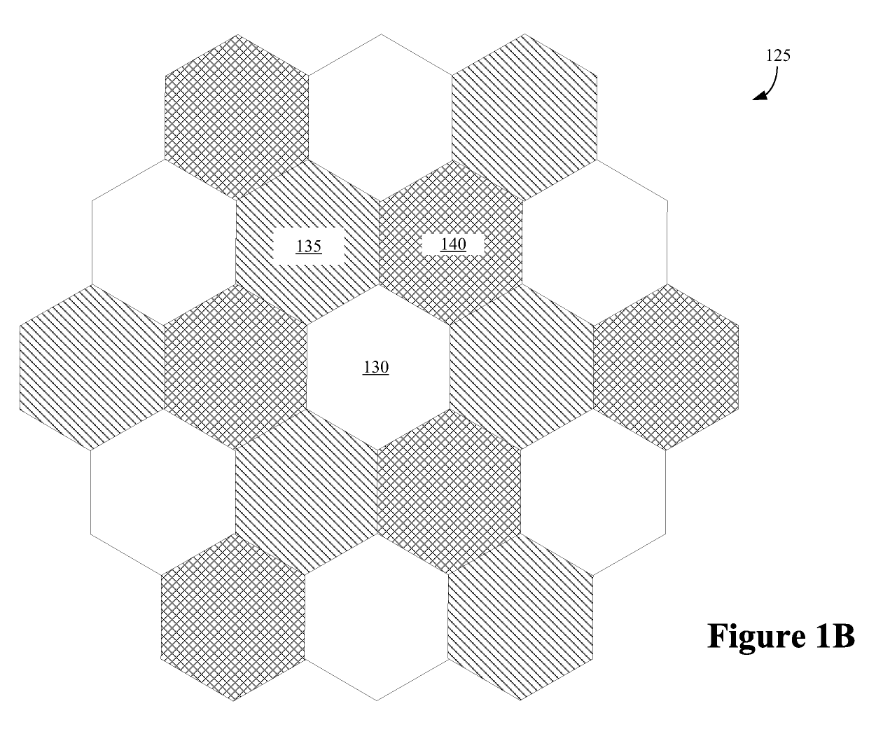

FIG. 1A conceptually illustrates a first exemplary embodiment of a wireless communication system 100. The first exemplary embodiment is a flat or distributed wireless communication system 100 that is implemented as a distributed architecture including a network of access points 105(1-2). The distinguishing indices (1-2) may be dropped when the access points 105 are referred to collectively. However, these indices may be used to indicate individual access points 105 and/or subsets of the access points 105. This convention may also be applied to other elements shown in the drawings that are indicated by an identifying numeral and one or more distinguishing indices. In the interest of clarity only two access points 105 are shown in FIG. 1. However, persons of ordinary skill in the art having benefit of the present disclosure should appreciate that the present invention is not limited to this particular embodiment and in alternative embodiments any number of access points 105 may be included in the wireless communication system 100. Furthermore, persons of ordinary skill in the art having benefit of the present disclosure should also appreciate that the present invention is not limited to distributed or flat wireless communication systems 100. Embodiments of the present invention may also be implemented in other types of network architectures including hierarchical wireless communication systems.

The access points 105 are used to provide wireless connectivity to one or more mobile units 110. In one embodiment, the access points 105 may be base station routers 105 that implement distributed communication network functionality. For example, each base station router 105 may combine RNC and/or PDSN functions in a single entity that manages radio links between one or more mobile units 110 and an outside network 115, such as the Internet. Base station routers 105 wholly encapsulate the cellular access technology and may proxy functionality that utilizes core network element support to equivalent IP functions. For example, IP anchoring in a UMTS base station router may be offered through a Mobile IP Home Agent (HA) and the GGSN anchoring functions that the base station router proxies by through equivalent Mobile IP signaling. The base station routers 105 may also be configured to communicate with other base station routers 105, other devices, other networks, and the like in a manner known to persons of ordinary skill in the art. Techniques for implementing and/or operating base station routers 105 are known in the art and in interest of clarity only those aspects of implementing and/or operating base station routers 105 that are relevant to the present invention will be discussed in detail herein. However, persons of ordinary skill in the art having benefit of the present disclosure should appreciate that the present invention is not limited to base station routers and in alternative embodiments any type of access point 105 may be used.

The mobile unit 110 may register with one of the access points 105 to establish a call session. Each access point 105 can create, assign, transmit, receive, and/or store information related to the call sessions established between the access points 105 and the mobile unit 1110. This information will be collectively referred to hereinafter as state information, in accordance with common usage in the art. For example, the state information may include security information associated with the call session, subscription information for broadcast and/or multicast services such as MBMS, home agent keys, information that may be used to connect to signal gateways in the wireless communication system 100, other link layer information, information related to an air interface protocol, one or more sequence numbers, a re-sequencing buffer, and the like. The state information may also include information related to a Packet Data Convergence Layer (PDCP), such as header compression information, payload compression information, and related parameters. State information related to other protocol layers may also be created, transmitted, received, and/or stored by the access points 105. This state information may be negotiated and/or generated during the registration procedure to establish the call session or during the call session itself.

A user of the mobile unit 110 may register for (or subscribe to) a multicast service provided by a multicast server 120, such as a MBMS service. The multicast server 120 may then multicast data associated with a multicast service to the mobile unit 110 over one or more air interfaces 125. In the illustrated embodiment, the access points 105 are part of a multicast group, such as an Internet Protocol multicast group, and are therefore all able to transmit information associated with the multicast service to the mobile unit 110 over the air interfaces 125. The ability of the mobile unit 110 to receive and/or decode information provided by the multicast server 120 may be significantly improved by transmitting encoded signals representative of the multicast data stream from the access points 105 in the multicast group on substantially orthogonal frequency channels. Persons of ordinary skill in the art having benefit of the present disclosure should appreciate that the term “substantially orthogonal” refers to signals received from multiple access points 105 over non-overlapping frequency channels that may not be fully orthogonal due to symbol boundary effects and the effects of Doppler spread and/or frequency offsets. The mobile unit 115 may then combine portions of the encoded signals when decoding these signals. The substantially orthogonal frequency channels may be assigned to the access points 105 using a frequency re-use pattern.

FIG. 1B conceptually illustrates a frequency re-use pattern 125 that may be implemented in the wireless communication systems 100. In the illustrated embodiment, the frequency re-use pattern 125 is a conventional ⅓ re-use pattern in which the cells or sectors 130 (indicated by open hexagons) are assigned a first frequency, subcarrier, or frequency band, the cells or sectors 135 (indicated by hashed hexagons) are assigned a second frequency, subcarrier, or frequency band substantially orthogonal to the first, and the cells or sectors 140 (indicated by crosshatched hexagons) are assigned a third frequency, subcarrier, or frequency band substantially orthogonal to the first and the second. Persons of ordinary skill in the art having benefit of the present disclosure should appreciate that the present invention is not limited to the ⅓ re-use pattern depicted in FIG. 1B and in alternative embodiments other re-use patterns may be used to assign substantially orthogonal frequencies (or bands of frequencies) to the cells or sectors 130, 135, 140.

Non-overlapping frequency bands can be allocated to different cells 130, 135, 140 either by using multi-carrier transmission where each cell 130, 135, 140 is assigned a different carrier frequency, or by employing OFDM modulation and using non-overlapping OFDM tones in different cells 130, 135, 140. If OFDM is used, then each cell 130, 135, 140 may be assigned a contiguous set of tones. Alternatively, tones assigned to one cell 130, 135, 140 may be interlaced with tones assigned to the other cells 130, 135, 140. The advantage of the former approach is that it may reduce inter-tone interference that may be the result of frequency offsets between neighboring cells 130, 135, 140 and/or Doppler shifts due to movement of a mobile receiver. The advantage of the latter approach is that by sampling the entire signal bandwidth for each cell 130, 135, 140, the frequency diversity gain for transmissions from each cell 130, 135, 140 may be increased.

In one embodiment, transmissions from the cells 130, 135, 140 may be tightly synchronized in time at the sub-symbol level. For example, the symbol timing across cells 130, 135, 140 may be synchronized to within a small fraction of the cyclic prefix, which is usually on the order of a few microseconds in typical cellular deployments. Alternatively, the transmissions from the cells 130, 135, 140 may be loosely synchronized or unsynchronized. The absence of time synchronization between cells 130, 135, 140 implies that the transmitted symbol boundaries can have arbitrary offsets between different cells 130, 135, 140. If this technique is employed in a synchronous network and if OFDM modulation is used, then the receiver processing may be simplified because a single Fast Fourier Transform (FFT) engine synchronized to the common timing can be used in the receiver to receive signals from all cells 130, 135, 140 in the monitored set. On the other hand, the absence of tight timing requirements between different cells 130, 135, 140 in an asynchronous system may permit a simplified network design at the expense of some increase in receiver complexity.

The packets transmitted from different cells 130, 135, 140 do not need to be synchronized even at the packet level. Thus, the same packet may be scheduled for transmission over the substantially orthogonal channels at random time instants in neighboring cells 130, 135, 140, regardless of whether the system is synchronized at the sub-symbol level. This feature may lift the burden of having to schedule the same packet at the same time from all the cells 130, 135, 140 despite possibly random relative delays with which the packet arrives at the different cells 130, 135, 140 over the backhaul network. For example, significant relative arrival delays may occur in networks that lack strict delay guarantees, such as conventional IP networks. Removing the need to synchronize packet transmissions may also reduce reliance on other possible packet synchronization techniques, such as having to time-stamp incoming packets to the different cells. 130, 135, 140

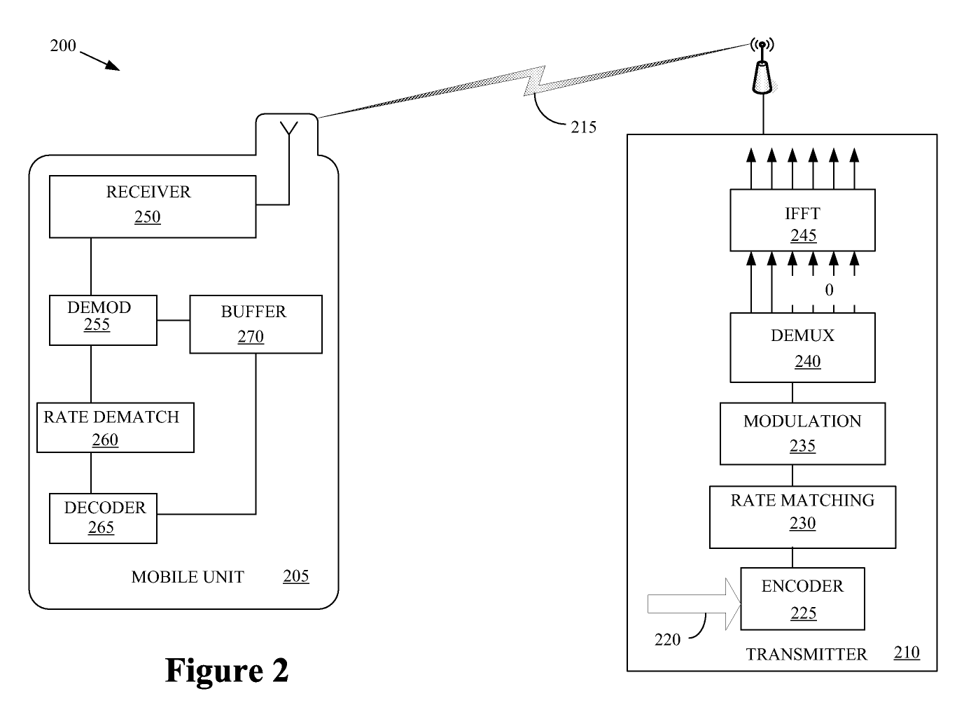

FIG. 2 conceptually illustrates a second exemplary embodiment of a wireless communication system 200. In the illustrated embodiment, the wireless communication system 200 includes a mobile unit 205 that receives encoded signals from a transmitter 210, such as the transmitter that may be located in an access point, a base station, a base station router, an access network, or another entity in the wireless communication system 200. The encoded signals are representative of packets in a multicast data stream and are received over an air interface 215 on a channel defined by one of a plurality of substantially orthogonal frequencies. Although a single transmitter 210 is shown in FIG. 2, the wireless communication system 200 will be understood to include multiple transmitters that also transmit encoded signals representative of the packets in the multicast data stream over channels defined by other frequencies in the plurality of substantially orthogonal frequencies. Accordingly, the encoded signals transmitted over the air interface 215 will be understood to be transmitted on a frequency that is substantially orthogonal to the other frequencies used by other transmitters. For example, the encoded signals transmitted by the various transmitters may be transmitted over channels defined by the substantially orthogonal frequencies of subcarriers in an Orthogonal Frequency Division Multiplexing (OFDM) system.

Packets 220 in the multicast data stream are provided to an encoder 225 in the transmitter 210. The encoder 225 encodes the packets according to a mother code, such as a Turbo or convolutional code. In the illustrated embodiment, encoders 225 in the transmitter 210 and the other transmitters that are also transmitting the multicast data stream use the same mother code to encode the packet. The encoded packet information is then provided to a rate matching unit 230 and a modulation unit 235. In various alternative embodiments, rate matching units 230 and/or modulation units 235 in the different transmitters may choose different physical channel bit-rates and/or different rate matching patterns to perform puncturing or repetition on the mother-coded packet. In one embodiment, if the number of mother coded bits for a packet are different (either smaller or larger) than the number of physical channel bits that are transmitted in any particular transmission, then rate matching is performed on the set of coded bits by repeating some of the coded bits or puncturing some of the coded bits, as appropriate. The set of bits that are either repeated or punctured is determined by the rate matching pattern that is used. If the transmissions from different cells use different rate matching patterns for the same packet, then by soft-combining the signals from the different cells, the receiver can obtain some additional coding advantage-called incremental redundancy (IR) gain—over a scheme in which the same rate matching pattern is used in all the cells. To obtain IR gain, each transmitter 210 may use rate matching patterns that are different from those used in the other cells and the mobile unit 205 may perform soft combining.

The modulated, rate matched signals are provided to a demultiplexer 240 that associates the signals with the frequencies and/or subcarriers that have been assigned to the transmitter 210 and provides them to an Inverse Fast Fourier Transform (IFFT) unit 245 for subsequent transmission over the air interface 215. In one embodiment, the demultiplexer 240 provides zero (or null) signals on channels associated with the frequencies and/or subcarriers that are not assigned to the transmitter 210 and which may be assigned to other transmitters for transmitting packets in the multicast data stream. The encoded signals transmitted over the substantially orthogonal frequencies may be accompanied by a separate control signal that identifies the packet sequence number for the corresponding multicast packet transmission. The control signal may be encoded separately to ensure that the sequence number can be decoded without first decoding the corresponding multicast transmission. Signals from the different transmitters may be synchronous or asynchronous. In an asynchronous system, transmissions of the multicast packets from the different cells are not tightly coordinated and can be scheduled at random time instants relative to each other.

A receiver 250 in the mobile unit 205 monitors the substantially orthogonal frequency channels associated with a set of cells from which the mobile unit 205 receives strong multicast signals. In the illustrated embodiment, this set of cells includes the transmitter 210. The mobile unit 205 includes a demodulator 255 that separately demodulates signals received from the different cells in the monitored set on the substantially orthogonal frequency channels. In one embodiment, a time window can be defined so that the receiver 250 waits for transmissions of a packet from its monitored cells starting from the time it receives the packet the first time from any cell until the time window closes. The size or duration of the time window is a matter of design choice and not material to the present invention.

The de-modulated signals may then be rate de-matched using a rate de-match unit 260 and the resulting soft symbols may be provided to a decoder 265 for decoding. For example, if the receiver 250 receives encoded signals indicative of a packet in the multicast data stream from a first cell, a second cell, and a third cell, in that order, then the decoder 265 may attempt to decode the first demodulated, rate de-matched signal (i.e., the soft symbol) received from the first cell. If the decoding is successful (successful decoding may be indicated by a CRC check or other technique), then the decoder 265 may store the decoded symbol and/or deliver the decoded multicast packet for use by higher layers.

However, if the decoding was unsuccessful, the post rate-dematched soft symbols are stored in a buffer 270. For example, the soft symbols may be stored in the buffer 270 and indexed by the packet sequence number associated with the soft symbol. The demodulator 255 and the rate de-matcher 260 may then compute soft symbols for the second signal, which may be added to the soft symbols stored in the buffer 270, e.g. the other soft symbols that share the same packet sequence number. The decoder 265 then attempts to decode the combined signal in the soft symbol buffer 270. If decoding fails again, the process of reception, buffer accumulation and decoding may be repeated for the third symbol. Each time a new transmission for the packet is added to the soft symbol buffer the accumulated signal energy is increased, thereby increasing the likelihood of correctly decoding the packet. Furthermore, the transmission from each cell does not interfere with transmissions from any other cell because of the difference in frequency bands.

In one alternative embodiment, soft symbol combining of transmissions from different cells may be replaced with hard combining, which does not require a soft symbol buffer 270. In the hard combining technique, the mobile unit 205 attempts to decode the signal received from each cell in the monitored set independently, without any combining of soft symbols between cells. If any of the decoding attempts is successful, the decoded packet is delivered for use by higher layers. The reduction of receiver complexity with the hard combining method may be obtained at the expense of a reduction in performance (achievable data rates) compared to the soft combining method.

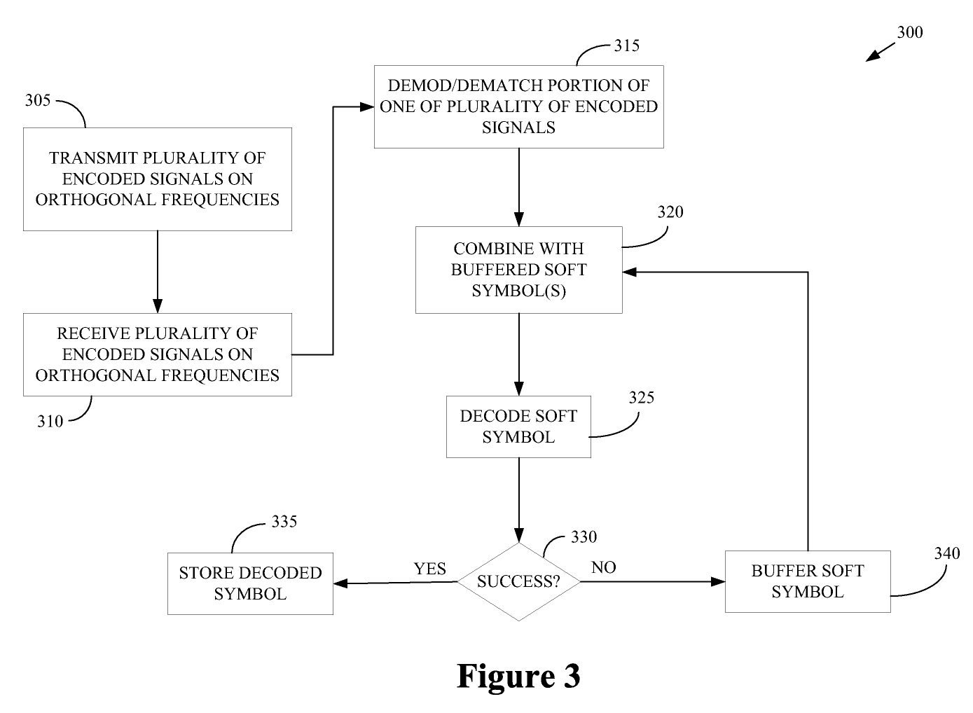

FIG. 3 conceptually illustrates one exemplary embodiment of a method 300 of a macro-diversity technique that may be used for multicasting in wireless communication systems. In the illustrated embodiment, a plurality of encoded signals representative of a single data stream, such as a multicast data stream, are transmitted (at 305) by a plurality of transmitters using substantially orthogonal frequencies. The encoded signals are then received (at 310) at a mobile unit, which may demodulate and/or rate de-match (at 315) portions of one of the plurality of encoded signals corresponding to a packet from the data stream. The demodulated and/or rate de-matched soft symbol may then be combined (at 320) with any existing previously demodulated and/or rate de-matched soft symbols corresponding to the same packet. The combined soft symbol may then be decoded (at 325). If the decoding is successful (at 330), then the decoded packet may be stored (at 335) and/or provided to higher layers for subsequent processing. If the decoding is not successful (at 330), then the soft symbol may be buffered (at 340) and additional portions of the plurality of encoded signals corresponding to encoded signals provided on another orthogonal frequency channel may be demodulated and/or de-matched (at 315) for subsequent decoding.

Embodiments of the techniques described herein may permit a network to achieve signal-to-interference-plus-noise ratios (SINR) that approach or match the SINRs achieved by the over-the-air combination of multicast data streams in a single frequency network, but without the onerous synchronization requirements that are necessary to implement single frequency networks. For example, if the channels are assumed to be ergodic in frequency in each block, then the capacity of any block or a user may be written as:

C(γ)=E{log(1+γ|h|²)},

where h is a circularly symmetric complex Gaussian with E{|h|²}=1 and γ is the combined symbol SINR. This expression can be reduced to

$$C ( γ ) = {e}^{1 / γ} {E}_{1} ( \frac{1}{γ} ) ,$$

where

$${E}_{1} ( x ) = {\int }_{x}^{∞} \frac{{e}^{- t}}{t} d t$$

is the exponential integral. If γ₁, γ₂, γ₃ are the average symbol SNRs from three cells to a mobile unit and each cell uses all of the available symbols or OFDM tones, then all M symbols transmitted by a single frequency network experience a SINR of γ₁+γ₂+γ₃ and the spectral efficiency is C(γ₁+γ₂+γ₃) bits per symbol. When symbols are transmitted on three orthogonal frequencies, as described herein, M/3 symbols see an SINR of 3γ₁, another M/3 symbols see an SINR of 3γ₂, and the remaining M/3 symbols see an SINR of 3γ₃. The average spectral efficiency is therefore (C(3γ₁)+C(3γ₂)+C(3γ₃))/3 bits per symbol. Consequently, when the signals received at the mobile unit from all three cells are equally strong, i.e. γ₁=γ₂=γ₃, a situation that is likely to occur or be approximated for users near the edges of the three cells, then the capacity achieved by the substantially orthogonal frequency technique described herein is the same as a single frequency network.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
receiving, at a mobile unit, a plurality of encoded signals indicative of at least one packet over a corresponding plurality of substantially orthogonal frequency channels associated with a plurality of transmitters;
demodulating the information indicative of said at least one packet using at least one of the plurality of encoded signals; and
storing the demodulated information.

2. The method of claim 1, wherein receiving the plurality of encoded signals comprises receiving a plurality of encoded signals indicative of at least one multicast packet.

3. The method of claim 1, wherein receiving the plurality of encoded signals comprises receiving the plurality of encoded signals from a plurality of transmitters associated with a corresponding plurality of cells or sectors.

4. The method of claim 1, wherein receiving the plurality of encoded signals comprises receiving at least one of a plurality of time-synchronized encoded signals or a plurality of encoded signals that arrive at random time intervals relative to each other.

5. The method of claim 1, wherein receiving the plurality of encoded signals comprises receiving a plurality of encoded signals that are encoded using the same mother code.

6. The method of claim 5, wherein receiving the plurality of encoded signals that are encoded using the same mother code comprises receiving a plurality of encoded signals that are encoded using different rate-matching patterns.

7. The method of claim 1, wherein receiving the plurality of encoded signals comprises receiving at least one control signal indicative of at least one packet sequence number associated with said at least one packet.

8. The method of claim 7, wherein receiving the plurality of encoded signals comprises identifying portions of the plurality of encoded signals that correspond to each of said at least one packet based on said at least one packet sequence number.

9. The method of claim 1, wherein decoding the information indicative of said at least one packet comprises:
demodulating one of the plurality of encoded signals;
storing at least one soft symbol formed from said one of the plurality of encoded signals if the demodulation is unsuccessful;
combining said at least one soft symbol with at least one other soft symbol formed from at least one other of the plurality of encoded signals; and
decoding the combined soft symbols.

10. A method, comprising:
transmitting, from a first transmitter, a first encoded signal indicative of at least one packet over a first frequency channel, at least one second encoded signal indicative of said at least one packet being transmitted by at least one second transmitter over at least one second frequency channel that is substantially orthogonal to the first frequency channel.

11. The method of claim 10, wherein transmitting the first encoded signal comprises transmitting a first encoded signal indicative of at least one multicast packet, and wherein said at least one second encoded signal is also indicative of said at least one multicast packet.

12. The method of claim 10, wherein transmitting the first encoded signal comprises transmitting the first encoded signal from a first transmitter associated with at least one of a cell or a sector, and wherein said at least one second encoded signal is transmitted by at least one second transmitter associated with at least one of a cell or a sector that differs from the cell or the sector associated with the first transmitter.

13. The method of claim 10, wherein transmitting the first encoded signal comprises transmitting a first encoded signal that is time-synchronized with said at least one second encoded signal.

14. The method of claim 10, wherein transmitting the first encoded signal comprises transmitting a first encoded signal at a random time interval relative to said at least one second encoded signal.

15. The method of claim 10, wherein transmitting the first encoded signal comprises transmitting a first encoded signal that is encoded using the same mother code as said at least one second encoded signal.

16. The method of claim 15, wherein transmitting the first encoded signal comprises transmitting a first encoded signal that is encoded using a different rate-matching pattern than said at least one second encoded signal.

17. The method of claim 10, comprising providing at least one control signal indicative of at least one packet sequence number associated with said at least one packet.

18. The method of claim 10, wherein transmitting the first encoded signal over the first frequency channel comprises transmitting the first encoded signal over a first frequency channel allocated according to a frequency re-use pattern, said at least one second frequency channel also being allocated according to the frequency re-use pattern.

19. The method of claim 10, wherein transmitting the first encoded signal over the first frequency channel comprises transmitting the first encoded frequency over a first frequency channel within a first frequency band allocated to the first transmitter, said at least one frequency channel being allocated to at least one second frequency band allocated to said at least one second transmitter.
